(19) United States
(12) Patent Application Publication
(10) Pub. No.: US 2008/0259602 A1
(43) Pub. Date: Oct. 23, 2008

(54) LIGHTING SYSTEM

(76) Inventors: Jorg Fechner, Mainz (DE); Franz Ott, Konnerstreuth (DE); Brigitte Hueber, Schwandorf (DE)

Correspondence Address: TAYLOR & AUST, P.C., P.O. Box 560, 142. S Main Street, Avilla, IN, 46710, US

(21) Appl. No.: 11/873,734

(22) Filed: Oct. 17, 2007

(30) Foreign Application Priority Data
Oct. 17, 2006 (DE) 102006048934.9-54

(51) Int. Cl. H01J 1/62; F21V 7/00; H01J 9/02

(52) U.S. Cl. 362/247; 313/486; 445/24

(57) ABSTRACT

The invention relates to a system for background lighting of displays or screens, including at least one lighting device including a glass envelope and a transparent element provided thereabove, at least one surface of the element being provided with a fluorescent layer on at least a portion of its surface.

### BACKGROUND OF THE INVENTION

1. Field of the Invention

The invention relates to a system, in particular a lighting system, referred to as a backlighting system, in particular for background lighting of displays, screens, or the like.

2. Description of the Related Art

A backlighting system for (flat) displays or screens essentially includes one or more light-generating and light-emitting units, and a reflector.

Gas discharge lamps, in particular fluorescent lamps or fluorescent tubes, are usually used as light-generating and light-emitting units for background lighting, referred to as back-lights. Mercury gas discharge tubes are also frequently used. Such light sources, in particular mercury discharge lamps, generate ultra violet (UV) radiation, in particular of a wavelength of 254 nm, which is converted to visible light by a fluorescent layer.

In the prior art the fluorescent layer is applied to the inner side of the glass envelope, i.e., in the interior of the lamp. One disadvantage is that for large-format displays, for example, in which more than 20 lamps are used, the fluorescent layer must be applied to and burned into the interior of each lamp tube. The fluorescent layer also undergoes “aging,” so that after a certain period of time when the luminance of the display decreases, the individual lamps or even the entire backlighting unit must be replaced. A further disadvantage is that for mercury vapor lamps, in particular low-pressure mercury discharge lamps, the mercury contained in the lamp reacts with the fluorescent layer, thereby degrading the fluorescent layer and thus changing the lighting characteristics of the lamp.

What is needed in the art is to avoid the disadvantages of the prior art. In particular, what is needed in the art is a backlighting system which allows simplified manufacture and facilitates repairs when the luminance decreases over time.

### SUMMARY OF THE INVENTION

The present invention provides a system, in particular a backlighting system, in particular for background lighting of displays or screens, including at least one lighting device having a glass envelope, a fluorescent layer being provided which is not applied to the interior or portion of the interior of an enveloping material, in particular a glass envelope of the lighting device. In a first possible design, the fluorescent material is applied, for example, to the exterior of the enveloping material. In a second design, the backlighting system includes, in addition to the lighting device, a transparent element which the radiation from the lighting device strikes, at least one surface of the element being provided on at least part of its surface with a fluorescent layer. On at least part of its surface the transparent element is particularly preferably provided with a fluorescent layer on a surface which the radiation from the lighting device strikes. This may be, for example, the surface located closest to the lighting device, i.e., the underside of the transparent element. However, other geometries are also possible.

The transparent element is not particularly limited within the scope of the invention. On the surface which the radiation strikes, the transparent element preferably has one or more layers which may be selected from glass and/or polymer material. Thus, for example, the element may have one or more superposed glass layers and/or polymer layers. A “layer” is understood to mean a flexible or nonflexible layer, film, or sheet of defined thickness and length, for example a glass sheet or plastic film. The number and size of the various layers depends on the backlighting system selected and its intended purpose. The shape of the transparent element is likewise not limited according to the invention, and, depending on the use of the backlighting system, the transparent element may have any given shape such as flat, curved, corrugated, bent on the corners, or other shapes, wherein symmetrical or nonsymmetrical shapes are also possible. The transparent element may also constitute a display element or a portion thereof, the underside of which is provided with a fluorescent layer.

According to one particularly preferred embodiment of the invention, the transparent element on its underside, i.e., on the surface facing the lighting device, has at least one layer made of plate glass, in particular selected from alkali-free plate glass, those from Schott AG being named as suitable examples.

According to the invention, “transparent” is understood to mean a transmission of preferably >80%, in particular >85%, more preferably >90%, very particularly preferably >95%, most particularly preferably >99%.

According to the invention, on at least one surface of the transparent element a fluorescent layer is applied to at least a portion of the surface. The fluorescent layer is not particularly limited according to the invention. The fluorescent layers used are known to one skilled in the art. Any known fluorescent material may be used, examples of which are listed below:

TABLE II
Phosphorus blends used in CCFL

| Blend | Red | Green | Blue |
|---|---|---|---|
| I | Y₂O₃:Eu | LaPO₄:Ce, Tb | (SrCaBaMg)₃(PO₄)₃Cl:Eu |
| II | Y₂O₃:Eu | MgAl₁₁O₁₉:Ce, Tb | BaMg₂Al₁₆O₂₇:Eu |

The fluorescent layer may have a partial or full-surface design. It is particularly preferred to apply the fluorescent layer over the full surface.

The fluorescent layer may be provided on the transparent element in any manner known to one skilled in the art. Thus, the fluorescent layer may be applied using a known coating method, for example, such as by spraying a solution of a fluorescent dye, by rotary coating, doctor blade coating, roller coating, dipping, application of a fluorescent film, or also screen printing.

According to one preferred embodiment of the invention, a polarization film or sheet is provided between the surface of the transparent element and the fluorescent layer. This is a flat polarizer used to ensure that essentially completely linearly polarized light strikes the entire surface. Such polarization films or sheets may be composed of, for example, dichroic crystals such as herapathite or tourmaline, or dichroic stretched polyvinyl alcohol films into which the dyes have been incorporated.

It is particularly preferred to provide an additional layer selected from glass, preferably thin plate glass, between the polarization film or sheet and the fluorescent layer. This is very thin plate glass having a thickness from fractions of a mm to the μm range, for example 80 μm to 0.7 mm thickness. The additional provision of thin plate glass, such as from Schott Desag, may be used as protection from interactions of the polarization film or sheet with the fluorescent layer.

The shape and dimensions of the transparent element may be such that it functions as a covering and/or as protection for the lighting device(s).

Any lighting device for this purpose known to one skilled in the art may be used as the lighting device according to the invention in the form of a back-light, such as discharge lamps, in particular those selected from gas discharge lamps, fluorescent tube lamps, fluorescent lamps, low-pressure lamps, in particular discharge lamps with high UV transmission, preferably in miniature form, very particularly preferably miniature low-pressure discharge lamps. The lighting device may optionally have external or internal electrodes, depending on the design selected.

Such a back-light lamp may be manufactured from drawn tubular glass, for example. The lighting device may be divided into a middle section, which preferably is substantially transparent and provided in the form of a glass envelope, and two ends which may be provided with corresponding leads by introducing metal or metal alloy wires. The metal or the metal wires may be fused with the glass envelope in a tempering step. The metal or the metal alloy wires are electrode leadthroughs and/or electrodes. These electrode leadthroughs are preferably tungsten or molybdenum metals or Kovar alloys. The coefficient of linear thermal expansion (CTE) of the glass envelope preferably matches the coefficient of linear expansion (CTE) of the electrode leadthroughs, so that in the region of the leadthroughs no stresses occur, or the stresses are used only in a defined and targeted manner.

External electrode fluorescent lamps (EEFLs) are particularly preferred back-light lamps. Such EEFLs are lighting devices without an electrode leadthrough, since in an electrodeless EEFL back-light the decoupling occurs by way of electrical fields. One example of a back-light system according to the invention corresponding to this variant is an electrodeless gas discharge lamp; i.e., there are no leadthroughs, only external and internal electrodes.

In principle, however, internal contacting is also possible. In this case the plasma may be ignited via internal electrodes. This type of ignition is an alternative technology. Such systems are referred to as cold-cathode fluorescent lamp (CCFL) systems.

The structure and design of the lighting device is not particularly limited according to the invention, it being preferred according to the invention to use miniature back-light lamp systems.

The backlighting system according to the invention usually has a reflector of practically any given shape, for example flat or curved, or also a multiply bent reflective base or support sheet or film. One or more lighting devices are situated above the reflector. It is preferred to use one or more individual, in particular miniature, lighting devices which, for example, may be configured parallel to one another. It is practical for the reflector to have multiple recesses in which the lighting device(s) is/are located. Each recess preferably contains one lighting device.

The glass of the lighting device is not particularly limited within the scope of the invention. Borosilicate-based glasses are particularly preferred for the glass envelopes of the lighting device for the backlighting system. Borosilicate glasses include as main components SiO₂ and B₂O₃, and as further components, alkali and/or alkali earth oxide, for example Li₂O, Na₂O, K₂O, CaO, MgO, SrO, and BaO. For particulars, reference is made to DE 20 2005 004 487 U1, the entire disclosed content of which is incorporated by reference into the present description.

The glass envelope preferably has a transmission >20%, particularly preferably >50%, and very particularly preferably >70% in the wavelength range of approximately 254 nm.

According to one preferred embodiment of the present invention, a glass composition is used for the glass envelope of the lighting device which has no UV-blocking effect; i.e., UV-blocking ions or the oxides thereof may be entirely absent in the glass compositions, or may be set to a minimum possible content. Examples are CeO₂, Fe₂O₃, and TiO₂.

This is achieved by a content of UV-blocking ions or the oxides thereof in the glass envelopes used, as follows:
TiO₂<0.1% by weight;
Fe₂O₃<0.02% by weight, preferably <0.01% by weight, particularly preferably <0.005% by weight, in particular <0.001% by weight;
CeO₂<0.1% by weight, preferably <0.05% by weight.

It is very particularly preferred that the glass envelopes for the lighting device have only one emission in the UV region up to 380 nm, and are opaque to radiation in the visible region of 380-800 nm. To this end, glass compositions may be selected which suppress transmission in the visible region. The glass therefore preferably contains Co²⁺ and/or Ni²⁺ to achieve absorption in the visible wavelength region. For example, glass compositions are preferred which contain CoO in a range of 0.2-10% by weight, preferably 0.2-5% by weight, particularly preferably 0.2-3% by weight, and/or NiO in a range of 0.2-15% by weight, preferably 0.2-10% by weight, particularly preferably 0.2-5% by weight.

The compositions of the glass envelopes according to the invention preferably lie within the following range:

| | | |
|---|---|---|
| SiO₂ | 55-85% | by weight, preferably 63-75% by weight, |
| | | in particular 65-74% by weight, |
| B₂O₃ | >0-35% | by weight, preferably 5-25% by weight, in |
| | | particular 14-19% by weight, |
| Al₂O₃ | 0-10% | by weight, preferably 1-8% by weight, |
| Li₂O | 0-10% | by weight, preferably 1-5% by weight, |
| Na₂O | 0-20% | by weight, preferably 1-15% by weight |
| K₂O | 0-20% | by weight, preferably 1-10% by weight, |
| wherein | | |
| Σ Li₂O + | 0-25% | by weight, preferably 1-15% by weight, |
| Na₂O + K₂O | | |
| and | | |
| MgO | 0-8% | by weight, preferably 1-5% by weight, |
| CaO | 0-20% | by weight, preferably 2-15% by weight, in |
| | | particular 2-10% by weight, |
| SrO | 0-5% | by weight, preferably 1-2% by weight, |
| BaO | 0-45% | by weight, preferably 5-25% by weight, |
| | | more preferably 0-15% by weight, |
| in particular | | |
| BaO | 0-5% | by weight, wherein |
| Σ MgO + CaO + | 0-45% | by weight, |
| SrO + BaO | | |
| in particular | 0-20% | by weight, particularly preferably 0-15% |
| | | by weight, and |
| ZrO₂ | 0-3% | by weight |
| WO₃ | 0-3% | by weight |
| Bi₂O₃ | 0-3% | by weight |
| MoO₃ | 0-3% | by weight, |

wherein
TiO₂ < 0.1% by weight and
Fe₂O₃ < 0.02% by weight, preferably <0.01% by weight,
particularly preferably <0.005% by weight, in particular <0.001% by
weight, and optionally, for high blocking in the visible wavelength region
the glass envelope of the EEFL lamp contains
CoO: 0.2-10% by weight, preferably 0.2-5% by weight, particularly
preferably 0.2-3% by weight, and/or
NiO: 0.2-15% by weight, preferably 0.2-10% by weight, particularly
preferably 0.2-5% by weight.

The lighting devices of the invention particularly preferably contain glass envelopes of the following composition:

| | | |
|---|---|---|
| SiO₂ | 55-79% | by weight, preferably 60-75% by weight, |
| | | in particular 65-70% by weight, |
| B₂O₃ | 3-25% | by weight, preferably 5-20% by weight, in |
| | | particular 14-19% by weight, |
| Al₂O₃ | 0-10% | by weight, preferably 0-5% by weight, |
| Li₂O | 0-10% | by weight, preferably 0-5% by weight, |
| Na₂O | 0-10% | by weight, preferably 0-5% by weight |
| K₂O | 0-10% | by weight, preferably 0-5% by weight, |
| wherein | | |
| Σ Li₂O + Na₂O + | 0.5-16% | by weight, preferably 1-12% by weight, |
| K₂O | | |
| and | | |
| MgO | 0-2% | by weight |
| CaO | 0-3% | by weight |
| SrO | 0-3% | by weight |
| BaO | 0-30% | by weight, preferably 0-20% by weight, |
| | | more preferably 0-10% by weight, |
| in particular | | |
| BaO | 0-3% | by weight, |
| ZnO | 0-30% | by weight, preferably 0-20% by weight, |
| | | more preferably 0-10% by weight, |
| in particular ZnO | 0-3% | by weight, |
| wherein | | |
| Σ MgO + CaO + | 0-30% | by weight, |
| SrO + BaO + | | |
| ZnO | | |
| in particular | 0-10% | by weight, and |
| ZrO₂ | 0-3% | by weight |
| WO₃ | 0-3% | by weight |
| Bi₂O₃ | 0-3% | by weight |
| MoO₃ | 0-3% | by weight, |

the melt being produced under oxidative conditions,
wherein
TiO₂ < 0.1% by weight and
Fe₂O₃ < 0.02% by weight, preferably <0.01% by weight,
particularly preferably <0.005% by weight, in particular <0.001%
by weight, and optionally, for high blocking of visible light with
wavelengths ≧380 mm
CoO is 0.2-10% by weight, preferably 0.2-5% by weight, particularly
preferably 0.2-3% by weight, and/or
NiO is 0.2-15% by weight, preferably 0.2-10% by weight, particularly
preferably 0.2-5% by weight. This glass composition preferably contains
0.01-1% by weight As₂O₃.

The above-referenced glass compositions may also be used for lighting devices having external electrodes, in which no fusing of the glass with electrode leadthroughs occurs, i.e., EEFLs. Such glasses have the following compositions, for example:

| | | |
|---|---|---|
| SiO₂ | 60-75% | by weight, preferably 65-70% by weight, |
| B₂O₃ | >25-35% | by weight, preferably 30-35% by weight, |
| Al₂O₃ | 0-10% | by weight, preferably 0-8% by weight, |
| Li₂O | 0-10% | by weight, preferably 0-5% by weight, |
| Na₂O | 0-20% | by weight, preferably 0-14% by weight, in particular 5-10% |
| | | by weight, |
| K₂O | 0-20% | by weight, preferably 0-14% by weight, in particular |
| | | 5-10% by weight, wherein |
| Σ Li₂O + Na₂O + K₂O | 0-25% | by weight, preferably 0-14% by weight, in particular |
| | | 5-10% by weight, and |
| MgO | 0-8% | by weight |
| CaO | 0-20% | by weight, preferably 0-14% by weight, more preferably |
| | | 0-10% by weight, |
| SrO | 0-5% | by weight |
| BaO | 0-45% | by weight, preferably 0-14% by weight, more preferably |
| | | 0-10% by weight, |
| in particular | | |
| BaO | 0-5% | by weight, wherein |
| Σ MgO + CaO +SrO + | 0-45% | by weight, preferably 0-14% by weight, more preferably |
| BaO | | 0-10% by weight, |
| in particular | 0-8% | by weight, and |
| ZnO | 0-30% | by weight, preferably 0-14% by weight, more preferably |
| | | 0-10% by weight, in particular |
| ZnO | 0-3% | by weight, and |
| ZrO₂ | 0-5% | by weight |
| MnO₂ | 0-1% | by weight |
| Nd₂O₃ | 0-1% | by weight |
| WO₃ | 0-2% | by weight |
| Bi₂O₃ | 0-5% | by weight |
| MoO₃ | 0-5% | by weight, |
| As₂O₃ | 0-1% | by weight |
| Sb₂O₃ | 0-1% | by weight |
| SO₄⁻² | 0-2% | by weight |
| Cl⁻ | 0-2% | by weight |
| F⁻ | 0-2% | by weight, wherein |

Σ PbO + As₂O₃ + Sb₂O₃ is 0-10% by weight, and wherein
Σ PdO + PtO₃ + PtO₂ + RhO₃ + Rh₂O₃ + IrO₂ + Ir₂O₃ is 0-0.1% by weight,
wherein
TiO₂ < 0.1% by weight and
Fe₂O₃ < 0.02% by weight, preferably <0.01% by weight, particularly preferably <0.005% by
weight, in particular <0.001% by weight,
and optionally, for high blocking in the visible wavelength region ≧380 nm, CoO is 0.2-10% by
weight, preferably 0.2-5% by weight, particularly preferably 0.2-3% by weight, and/or
NiO is 0.2-15% by weight, preferably 0.2-10% by weight, particularly preferably 0.2-5% by
weight.

As described above, as the result of the low content of UV-blocking ions, for example titanium or iron, the glasses are very transparent in the UV region.

According to one particularly preferred embodiment of the invention, the glasses are designed in particular for gas discharge lamps having external electrodes. To minimize the power loss Pₗₒₛₛ and thus achieve high efficiency of the gas discharge lamps having external electrodes, it has proven to be particularly advantageous when the quotient of the loss angle tan δ and the dielectric constant ∈′ is as low as possible. For a simple geometry with planar electrodes on the end faces of a closed glass tube, the power loss may be approximately described as follows:

$${P}_{loss} \approx 2 \cdot \frac{1}{ω} \cdot \frac{tan δ}{{ɛ}^{′}} \cdot \frac{d}{A} \cdot {I}^{2}$$

wherein
ω: Angular frequency
tan δ: Power loss
∈′: Dielectric constant
d: Thickness of the capacitor (here, thickness of the glass)
A: Current intensity on the electrode surface
I: Current intensity

For use for EEFL, therefore, the quotient ((tan δ)/∈′)<5×10⁻⁴, preferably <4×10⁻⁴, particularly preferably <3×10⁻⁴, very particularly preferably <2.5×10⁻⁴, in particular <1.5×10⁻⁴, and most preferably <1×10⁻⁴.

Thus, by adjusting the quotient tan δ/∈′ in the range below 5×10⁻⁴ the glass properties are influenced in a targeted manner, thus enabling the desired overall power loss to be minimized. To set the quotient of tan δ and ∈′ to be as small as possible according to the invention, the glass composition contains, for example, highly polarizable elements in oxidic form incorporated into the glass matrix. Such highly polarizable elements in oxidic form may be selected from the group including the oxides of Ba, Cs, Hf, Ta, W, Re, Os, Ir, Pt, Pb, Bi, La, Pr, Nd, Sm, Eu, Gd, Tb, Dy, Ho, Er, Tm, Yb, and/or Lu.

For an EEFL discharge lamp, the glass therefore preferably has the following composition:

| | | |
|---|---|---|
| SiO₂ | 55-85% | by weight, preferably 60-80% by weight, |
| | | in particular 70-80% by weight, |
| | >0-35% | by weight, preferably >0-10% by weight, |
| B₂O₃ | | particularly >0-5% by weight |
| Al₂O₃ | 0-25% | by weight, |
| preferably | 0-20% | by weight, |
| in particular | 0-15% | by weight |
| Li₂O | <1.0% | by weight |
| Na₂O | <3.0% | by weight |
| K₂O | <5.0% | by weight, wherein |
| Σ Li₂O + Na₂O + | 0-8% | by weight, and |
| K₂O | | |
| MgO | 0-8% | by weight |
| CaO | 0-20% | by weight, preferably 0-10% by weight, |
| SrO | 0-20% | by weight, preferably 0-10% by weight, |
| BaO | 0-80% | by weight, preferably 0-44% by weight, |
| | | more preferably 0-20% by weight, |
| in particular | | |
| BaO | 0-8% | by weight, |
| preferably | >0.5-8% | by weight, |
| ZrO₂ | 0-3% | by weight |
| WO₃ | 0-3% | by weight |
| Bi₂O₃ | 0-80% | by weight, preferably 0-44% by weight, |
| | | more preferably 0-20% by weight, |
| MoO₃ | 0-3% | by weight, |
| ZnO | 0-15% | by weight, |
| preferably | 0-5% | by weight, |
| PbO | 0-70% | by weight, preferably 0-44% by weight, |
| | | more preferably 0-20% by weight, |
| | | wherein |

Σ AI₂O₃ + B₂O₃ + BaO + PbO + Bi₂O₃ is 15-80% by weight,
preferably 15-44% by weight,
wherein Hf, Ta, W, Re, Os, Ir, Pt, La, Pr, Nd, Sm, Eu, Gd, Tb, Dy, Ho,
Er, Tm, Yb, and/or Lu are present in oxidic form in contents of 0-80%
by weight, preferably 0-29% by weight,
and refining agent in customary concentrations,
wherein for a high transmission in the UV region
TiO₂ < 0.1% by weight and
Fe₂O₃ < 0.02% by weight, preferably <0.01% by weight, particularly
preferably <0.005% by weight, in particular <0.001% by weight,
and optionally, for high blocking in the visible wavelength
region ≧380 nm, CoO is 0.2-10% by weight, preferably 0.2-5% by
weight, particularly preferably 0.2-3% by weight, and/or NiO is 0.2-15%
by weight, preferably 0.2-10% by weight, particularly preferably 0.2-5%
by weight. The glass is preferably free of alkali, with the exception of
unavoidable impurities.

One particularly preferred embodiment for the use as glass envelopes in EEFL lamps is also the following:

| | | |
|---|---|---|
| SiO₂ | 0-85% | by weight, preferably 0-70% by weight |
| B₂O₃ | >0-35% | by weight, preferably >0-10% by weight, |
| | | particularly preferably >0-5% by weight |
| Al₂O₃ | 0-20% | by weight |
| Li₂O | <0.5% | by weight |
| Na₂O | <0.5% | by weight |
| K₂O | <0.5% | by weight, wherein |
| Σ Li₂O + Na₂O + | <1.0% | by weight, and |
| K₂O | | |
| MgO | 0-8% | by weight |
| CaO | 0-20% | by weight |
| SrO | 0-20% | by weight |
| BaO | 15-60% | by weight, in particular |
| BaO | 20-35% | by weight, more preferably 25-30% by |
| | | weight, wherein |
| Σ MgO + CaO + | 15-70% | by weight, |
| SrO + BaO | | |
| in particular | 20-40% | by weight, more preferably 25-30% by |
| | | weight, and |
| ZrO₂ | 0-3% | by weight |
| WO₃ | 0-3% | by weight |
| Bi₂O₃ | 0-80% | by weight, preferably 0-70% by weight, |
| | | more preferably 20-40% by weight, |
| MoO₃ | 0-3% | by weight, |
| ZnO | 0-10% | by weight, |
| preferably | 0-5% | by weight, |
| PbO | 0-70% | by weight, preferably 0-60% by weight, |
| | | more preferably 20-40% by weight, in |
| | | particular 25-30% by weight, wherein |

Σ AI₂O₃ + B₂O₃ + BaO + Cs₂O + PbO + Bi₂O₃ is 15-80% by
weight, preferably 30-60% by weight, more preferably 35-45% by weight,
in particular 25-35% by weight,
and refining agent in customary concentrations,
wherein for a high transmission in the UV region
TiO² < 0.1% by weight and
Fe₂O₃ < 0.02% by weight, preferably <0.01% by weight, particularly
preferably <0.005% by weight, in particular <0.001% by weight,
and optionally, for high blocking in the visible wavelength
region ≧380 nm, CoO is 0.2-10% by weight, preferably 0.2-5% by
weight, particularly preferably 0.2-3% by weight, and/or NiO is 0.2-15%
by weight, preferably 0.2-10% by weight, particularly preferably 0.2-5%
by weight. The glass is preferably free of alkali, with the exception
of unavoidable impurities.

Glasses as described above, i.e., having a very broad SiO₂ range from 0 to 85% by weight, preferably have an SiO₂ fraction in the range of 55-85%. The B₂O₃ fraction is then adjusted accordingly. It is understood that the components of the particular glass composition add up to 100% by weight.

Further preferred glass compositions for use in EEFL lamps include the following:

| | | |
|---|---|---|
| SiO₂ | 35-65% | by weight, preferably 40-64% by weight, |
| | | more preferably 45-55% by weight, in |
| | | particular 45-58% by weight, |
| B₂O₃ | 0-15% | by weight, preferably 0-12% by weight, |
| | | more preferably 1-8% by weight, |
| Al₂O₃ | 0-20% | by weight, in particular 8-14% by weight, |
| Li₂O | 0-0.5% | by weight |
| Na₂O | 0-0.5% | by weight |
| K₂O | 0-0.5% | by weight, wherein |
| Σ Li₂O + Na₂O + | 0-1% | by weight, and |
| K₂O | | |
| MgO | 0-6% | by weight |
| CaO | 0-15% | by weight, preferably 0-10% by weight |
| SrO | 0-8% | by weight |
| BaO | 1-20% | by weight, in particular |
| BaO | 1-10% | by weight, more preferably 2-8% by weight, |
| ZrO₂ | 0-1% | by weight |
| WO₃ | 0-2% | by weight |
| Bi₂O₃ | 0-20% | by weight, preferably 0-15% by weight, |
| | | more preferably 1-10% by weight, |
| | | in particular 2-8% by weight, |
| MoO₃ | 0-5% | by weight, |
| ZnO | 0-5% | by weight, |
| preferably | 0-3% | by weight, |
| PbO | 0-70% | by weight, preferably 0-64% by weight, |
| | | more preferably 20-40% by weight, in |
| | | particular 25-35% by weight, wherein |

Σ AI₂O₃ + B₂O₃ + BaO + PbO + Bi₂O₃ is 8-65% by
weight, preferably 8-64% by weight, more preferably 10-40% by weight,
in particular 20-35% by weight, wherein Hf, Ta, W, Re, Os, Ir, Pt, La,
Pr, Nd, Sm, Eu, Gd, Tb, Dy, Ho, Er, Tm, Yb, and/or Lu are present in
oxidic form in contents of 0-80% by weight, preferably 0-64% by weight,
more preferably 10-40% by weight, in particular 20-35% by weight,
and refining agent in customary concentrations,
wherein for a high transmission in the UV region
TiO₂ < 0.1% by weight and
Fe₂O₃ < 0.02% by weight, preferably <0.01% by weight,
particularly preferably <0.005% by weight, in particular <0.001% by
weight, and optionally, for high blocking in the visible wavelength
region ≧380 nm, CoO is 0.2-10% by weight, preferably 0.2-5% by
weight, particularly preferably 0.2-3% by weight, and/or NiO is
0.2-15% by weight, preferably 0.2-10% by weight, particularly
preferably 0.2-5% by weight.

Yet further glasses, which, like the above-referenced glass compositions also have a quotient of tan δ/∈′<5×10−4 due to the presence of at least one highly polarizable oxide in a relatively high quantity, and are advantageous in particular for use in EEFL lamps, have the following compositions:

| | | |
|---|---|---|
| SiO₂ | 50-65% | by weight, preferably 55-60% by weight, |
| B₂O₃ | 0-15% | by weight, preferably >1-12% by weight, |
| | | particulnriy 2-10% by weight, |
| Al₂O₃ | 1-17% | by weight, preferably 2-15% by weight, |
| | | more preferably 5-14% by weight, |
| Li₂O | 0-0.5% | by weight |
| Na₂O | 0-0.5% | by weight |
| K₂O | 0-0.5% | by weight, wherein |
| Σ Li₂O + Na₂O + | 0-1% | by weight, and |
| K₂O | | |
| MgO | 0-5% | by weight |
| CaO | 0-15% | by weight, preferably 0-10% by weight, |
| | | more preferably 1-8% by weight, |
| SrO | 0-5% | by weight |
| BaO | 20-49% | by weight, preferably 20-45% by weight, |
| more preferably | | |
| BaO | 20-40% | by weight, in particular 20-39% by weight, |
| ZrO₂ | 0-1% | by weight |
| WO₃ | 0-2% | by weight |
| Bi₂O₃ | 0-29% | by weight, preferably 0-19% by weight, |
| | | more preferably 0-10% by weight, |
| MoO₃ | 0-5% | by weight, |
| ZnO | 0-3% | by weight, |
| PbO | 0-29% | by weight, preferably 0-20% by weight, |
| | | more preferably 0-10% by weight, |
| | | in particular |
| PbO | 10-20% | by weight, wherein |

Σ AI₂O₃ + B₂O₃ + BaO + PbO + Bi₂O₃ is 21-50% by
weight, more preferably 15-30% by weight, wherein
Hf, Ta, W, Re, Os, Ir, Pt, La, Pr, Nd, Sm, Eu, Gd, Tb, Dy, Ho, Er, Tm,
Yb, and/or Lu are present in oxidic form in contents of 0-29% by weight,
preferably 0-18% by weight,
and refining agent in customary concentrations,
wherein for a high UV transmission
TiO₂ < 0.1% by weight and
Fe₂O₃ < 0.02% by weight, preferably <0.01% by weight, particularly
preferably <0.005% by weight, in particular <0.001% by weight,
and optionally,
CoO is 0.2-10% by weight, preferably 0.2-5% by weight, particularly
preferably 0.2-3% by weight, and/or
NiO is 0.2-15% by weight, preferably 0.2-10% by weight, particularly
preferably 0.2-5% by weight.

The following glass compositions are also preferred, independent of the lighting devices used:

| | | |
|---|---|---|
| SiO₂ | 63-72% | by weight, preferably 65-70% by weight, |
| B₂O₃ | 15-22% | by weight, preferably 18-20% by weight, |
| Al₂O₃ | 0-3% | by weight |
| Li₂O | 0-5% | by weight |
| Na₂O | 0-5% | by weight |
| K₂O | 0-5% | by weight, wherein |
| Σ Li₂O + Na₂O + | 0.5-8% | by weight, and |
| K₂O | | |
| MgO | 0-3% | by weight |
| CaO | 0-5% | by weight |
| SrO | 0-3% | by weight |
| BaO | 0-30% | by weight, preferably 0-22% by weight, |
| | | more preferably 2-20% by weight, in |
| | | particular 5-15% by weight, |
| in particular | | |
| BaO | 0-3% | by weight, wherein |
| Σ MgO + CaO + | 0-30% | by weight, preferably 0-22% by weight, |
| SrO + BaO | | more preferably 2-15% by weight, in |
| | | particular 5-12% by weight, |
| in particular | 0-5% | by weight, and |
| ZnO | 0-30% | by weight, preferably 0-22% by weight, |
| | | more preferably 2-15% by weight, in |
| | | particular 5-10% by weight, in particular |
| ZnO | 0-3% | by weight, |
| ZrO₂ | 0-5% | by weight |
| MnO₂ | 0-1.0% | by weight |
| Nd₂O₃ | 0-1.0% | by weight |
| WO₃ | 0-2% | by weight |
| Bi₂O₃ | 0-5% | by weight |
| MoO₃ | 0-5% | by weight, |
| As₂O₃ | 0-1% | by weight |
| Sb₂O₃ | 0-1% | by weight |
| SO₄⁻² | 0-2% | by weight |
| Cl⁻ | 0-2% | by weight |
| F⁻ | 0-2% | by weight, wherein |

Σ PbO + As₂O₃ + Sb₂O₃ + Cl is 0.005-10% by weight
wherein for a high UV transmission
TiO₂ < 0.1% by weight and
Fe₂O₃ < 0.02% by weight, preferably <0.01% by weight, particularly
preferably <0.005% by weight, in particular <0.001% by weight,
and optionally,
CoO is 0.2-10% by weight, preferably 0.2-5% by weight, particularly
preferably 0.2-3% by weight, and/or
NiO is 0.2-15% by weight, preferably 0.2-10% by weight, particularly
preferably 0.2-5% by weight.

A further preferred composition contains the following:

| | | |
|---|---|---|
| SiO₂ | 67-74% | by weight, preferably 68-72% by weight, |
| B₂O₃ | 5-10% | by weight, preferably 7-10% by weight, |
| Al₂O₃ | 3-10% | by weight, preferably 5-8% by weight, |
| Li₂O | 0-4% | by weight |
| Na₂O | 0-10% | by weight, preferably 1-8% by weight, |
| | | more preferably 2-7% by weight |
| K₂O | 0-10% | by weight, preferably 1-8% by weight, |
| | | more preferably 2-7% by weight, |
| | | wherein |
| Σ Li₂O + Na₂O + | 0.5-10.5% | by weight, preferably 1-8% by weight, |
| K₂O | | more preferably 2-7% by weight, |
| MgO | 0-2% | by weight |
| CaO | 0-3% | by weight |
| SrO | 0-3% | by weight |
| BaO | 0-30% | by weight, preferably 0-20% by weight, |
| | | more preferably 0-10% by weight, |
| in particular | | |
| BaO | 0-3% | by weight |
| ZnO | 0-30% | by weight, preferably 0-24.5% by weight, |
| | | more preferably 0-10% by weight, |
| | | in particular |
| ZnO | 0-3% | by weight, wherein |
| Σ MgO + CaO + | 0-30% | by weight, preferably 0-24.5% by weight, |
| SrO + BaO + | | more preferably 0-10% by weight, |
| ZnO | | |
| in particular | 0-6% | by weight, and |
| ZrO₂ | 0-3% | by weight, |
| MnO₂ | 0-1.0% | by weight |

wherein for a high UV transmission
TiO₂ < 0.1% by weight and
Fe₂O₃ < 0.02% by weight, preferably <0.01% by weight,
particularly preferably <0.005% by weight, in particular <0.001% by
weight, and optionally, for high blocking in the visible wavelength
region ≧380 nm, CoO is 0.2-10% by weight, preferably 0.2-5% by
weight, particularly preferably 0.2-3% by weight, and/or
NiO is 0.2-15% by weight, preferably 0.2-10% by weight, particularly
preferably 0.2-5% by weight.

The above-referenced borosilicate glasses in particular are suited for use in gas discharge tubes and fluorescent lamps, in particular miniature fluorescent lamps, and are very particularly suited for lighting, especially for background lighting of electronic display devices, such as displays and LCD screens, for mobile telephones and computer monitors, for example, and find application in the manufacture of liquid crystal displays (LCDs) and back-lit displays (“non-self-emitters”) as a light source.

For this application, such lamps have very small dimensions, and the lamp glass accordingly is extremely thin. For example, the glass envelope may have a tubular shape, the diameter of the tubular glass envelope preferably being <1.0 cm, particularly preferably <0.8 cm, more particularly preferably <0.7 cm, very particularly preferably <0.5 cm. The wall thickness of the tubular glass envelope is <1 mm, in particular <0.7 mm. In one alternative design the glass envelope for the lighting device may be plate glass with a thickness of <1 cm. Preferred displays and screens are flat displays, used in laptops, and in particular flat back-light systems. The backlighting systems according to the invention are particularly suited for non-self emitter displays such as LCD TFTs, for example.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawing, wherein:

FIG. 1 shows a schematic view of an embodiment of a backlighting system of the present invention.

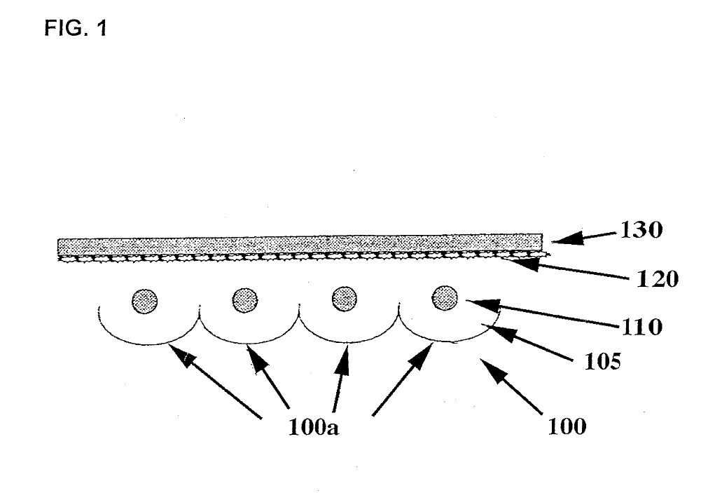

Corresponding reference characters indicate corresponding parts throughout the several views. The exemplification set out herein illustrates one embodiment of the invention, and such exemplification is not to be construed as limiting the scope of the invention in any manner.

### DETAILED DESCRIPTION OF THE INVENTION

Referring now to the drawing, there is shown individual miniature discharge lamps 110, for example EEFLs or CCFLs, are shown which are provided in recesses 100a of a reflector 100. The discharge lamps 110 are mounted in parallel and have the same dimensions. However, this illustration is for example only, and of course other configurations and dimensions are possible. In addition, the reflector, which in particular reflects UV light, may have a completely different geometry in another backlighting system. In the illustration shown, the light, in particular UV light, reflected from the reflector 100 is reflected to the display surface 130. In the present case, a reflective layer 105 is applied to the reflector 100 which uniformly reflects or disperses the light, in particular UV light, emitted from the discharge lamp 110 in the direction of the element 130, thereby providing homogeneous illumination of the display. The luminous power of the display may be increased considerably by providing the reflector with a metallic layer, for example, which in particular reflects UV light. This is possible because the reflectors act as a type of collector for light, and collect the rearwardly emitted light from the discharge lamp 110, focus it, and reflect or disperse the light in the direction of the uniformly transparent element. According to the invention, the transparent element 130 may be composed, for example, of any given polymer such as a polycarbonate or methacrylate (PMMA). Alternatively, the element is made of glass, in particular plate glass, preferably alkali-free plate glass. In the present case, a fluorescent layer 120 is applied to the underside of the transparent element 130 on the surface which the radiation from the lighting device strikes. This layer may be composed of or contain any given fluorescent material, for example a fluorescent dye. This fluorescent layer of the transparent element 130 converts the UV light emitted from the lighting device, for example <380 nm, in particular <300 nm, into visible light. The visible light produced by the conversion by way of the fluorescent layer preferably lies in the wavelength region of 380 nm to 800 nm.

A polarization film may be inserted between the fluorescent layer 120 and the transparent element 130.

The polarization film, which preferably is composed of a polymer, may be inserted by the additional introduction of thin plate glass as described in WO00/66507, for example, thus preventing the polymer of the polarization film from coming into direct contact with the fluorescent dye in the fluorescent layer 120.

In one preferred embodiment, the discharge lamps are designed in such a way that the lamp, i.e., the lighting device, essentially emits only light of wavelength <380 nm, preferably UV radiation in the wavelength range 200 nm-380 nm, preferably 250 nm-320 nm. In essence, this means that preferably greater than 75%, more preferably greater than 80%, particularly preferably greater than 85%, more particularly preferably greater than 90%, very particularly preferably greater than 95%, most particularly preferably greater than 97% of the luminous power of the lamp is emitted in this spectral region, i.e., between 200 nm and 380 nm. For low-pressure mercury lamps the primary emission is in the region of 254 nm.

To enable the radiation emitted from the lamp to reach the exterior layer, the glass envelope of the lamp, for example the tubular glass envelope, is preferably a glass which has high transmission in the 200-380 nm range, and essentially blocks radiation in the visible wavelength region, i.e., above 380 nm, preferably above 450 nm, for example by absorption or reflection. The glass envelope preferably contains Co²⁺ and/or Ni²⁺ to achieve high absorption in the visible wavelength region. The situation is different for lamps according to the prior art having an inner coating of the fluorescent layer. In this case, the glass envelope is designed such that, in contrast to the present invention, it has high transmission in the visible wavelength region and essentially blocks UV radiation. Glass compositions for glass envelopes having high UV transmission and blocking in the visible wavelength region are mentioned in the Summary of the Invention above.

The glass envelope preferably has a transmission less than 20%, particularly preferably less than 10%, very particularly preferably less than 8%, most particularly preferably less than 5%, in the 450 to 800 nm wavelength region. Furthermore, the glass envelope is designed in such a way that a transmission greater than 80%, preferably greater than 85%, particularly preferably greater than 90%, and most particularly preferably greater than 95% is present in the 250 to 380 nm wavelength region.

The present invention has numerous advantages.

The present invention provides backlighting systems in which a fluorescent layer is situated external to the lighting device, for example on the exterior of the lighting device or on the underside of an additional transparent element. In this manner the fluorescent layer is not degraded by materials inside the lighting device, thus preventing a shift of the spectral region of the emitted fluorescent radiation after the system has operated for some time.

A further advantage is that by applying the fluorescence not on the interior of the lighting device but instead external to the lighting device, i.e., either on the exterior of the glass which encloses the lighting device or on an externally situated transparent element, a fluorescent layer is applied by way of which a costly inner coating may be avoided.

The design of the invention in which a flat substrate glass is coated with a fluorescent layer is particularly advantageous, since flat substrate glass can be coated with the fluorescent layer, for example a polymer layer containing fluorescent dye. Dipping processes, for example, are suitable coating processes.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A backlighting system for background lighting of at least one of a display and a screen, said backlighting system comprising:
at least one lighting device including a glass envelope which has an inner wall and a fluorescent layer, said fluorescent layer not being applied to said inner wall.

2. A backlighting system for background lighting of at least one of a display and a screen, said backlighting system comprising:
at least one lighting device including a glass envelope which has an inner wall and a fluorescent layer, said fluorescent layer being one of completely and partially applied to said inner wall of said glass envelope.

3. A backlighting system for background lighting of at least one of a display and a screen, said backlighting system comprising:
at least one lighting device including a glass envelope and being configured for emitting a radiation;
a transparent element including at least one surface and being configured for being struck by said radiation of said at least one lighting device; and
a fluorescent layer applied to at least a portion of said at least one surface of said transparent element.

4. The backlighting system according to claim 3, wherein said at least one surface is configured for being struck by said radiation.

5. The backlighting system according to claim 3, wherein said transparent element includes at least one layer.

6. The backlighting system according to claim 5, wherein said at least one layer of said transparent element is selected from at least one of a glass and a polymer material.

7. The backlighting system according to claim 5, wherein one of said at least one layer of said transparent element is one of a sheet and a film.

8. The backlighting system according to claim 5, wherein at least one of said at least one layer of said transparent element is selected from a plate glass.

9. The backlighting system according to claim 8, wherein said plate glass is an alkali-free plate glass.

10. The backlighting system according to claim 3, further comprising a reflector configured for reflecting UV light from said at least one lighting device.

11. The backlighting system according to claim 3, further comprising one of a polarization film and a polarization sheet between said transparent element and said fluorescent layer.

12. The backlighting system according to claim 11, further comprising an additional layer selected from a glass, said additional layer being between said fluorescent layer and one of said polarization film and said polarization sheet.

13. The backlighting system according to claim 12, wherein said additional layer is a thin plate glass.

14. The backlighting system according to claim 3, wherein said transparent element is configured for at least one of covering and protecting said at least one lighting device.

15. The backlighting system according to claim 3, wherein said transparent element has at least one of a flat and a curved shape.

16. The backlighting system according to claim 3, wherein said at least one lighting device includes at least one discharge lamp selected from a gas discharge lamp, a fluorescent tube lamp, a fluorescent lamp, and a low-pressure lamp.

17. The backlighting system according to claim 16, wherein said at least one discharge lamp is selected from a discharge lamp with high UV transmission, a discharge lamp in miniature form, and a miniature low-pressure discharge lamp.

18. The backlighting system according to claim 3, wherein said glass envelope has a transmission less than 10% in a range of 450 nm to 800 nm.

19. The backlighting system according to claim 3, wherein said glass envelope has a transmission greater than 80% in a range of 250 nm to 380 nm.

20. The backlighting system according to claim 3, wherein said glass envelope includes TiO₂ in a content <0.1% by weight and Fe₂O₃ in a content <0.02% by weight.

21. The backlighting system according to claim 3, wherein said glass envelope includes at least one of CoO in a content of 0.2-10% by weight and NiO in a content of 0.2-15% by weight.

22. The backlighting system according to claim 3, wherein said glass envelope has the following compositions:

| | | |
|---|---|---|
| SiO₂ | 55-85% | by weight |
| B₂O₃ | >0-35% | by weight |
| Al₂O₃ | 0-10% | by weight |
| Li₂O | 0-10% | by weight |
| Na₂O | 0-20% | by weight |
| K₂O | 0-20% | by weight, wherein |
| Σ Li₂O + Na₂O + K₂O | 0-25% | by weight, |
| MgO | 0-8% | by weight |
| CaO | 0-20% | by weight |
| SrO | 0-5% | by weight |
| BaO | 0-30% | by weight, wherein |
| Σ MgO + CaO + SrO + BaO | 0-30% | by weight, |
| ZrO₂ | 0-3% | by weight |
| WO₃ | 0-3% | by weight |
| Bi₂O₃ | 0-3% | by weight |
| MoO₃ | 0-3% | by weight, |

wherein
TiO₂ < 0.1% by weight and
Fe₂O₃ < 0.02% by weight.

23. The backlighting system according to claim 22, wherein said glass envelope includes one of CoO being 0.2-10% by weight and NiO being 0.2-15% by weight.

24. The backlighting system according to claim 3, wherein said glass envelope has the following compositions:

| | | |
|---|---|---|
| SiO₂ | 0-85% | by weight |
| B₂O₃ | >0-35% | by weight |
| Al₂O₃ | 0-25% | by weight |
| Li₂O | <1.0% | by weight |
| Na₂O | <3.0% | by weight |
| K₂O | <5.0% | by weight, wherein |
| Σ Li₂O + Na₂O + K₂O | <5.0% | by weight, and |
| MgO | 0-8% | by weight |
| CaO | 0-20% | by weight |
| SrO | 0-20% | by weight |
| BaO | 0-80% | by weight, |
| ZrO₂ | 0-3% | by weight |
| WO₃ | 0-3% | by weight |
| Bi₂O₃ | 0-80% | by weight |
| MoO₃ | 0-3% | by weight, |
| ZnO | 0-15% | by weight, |
| PbO | 0-70% | by weight, wherein |

Σ AI₂O₃ + B₂O₃ + BaO + PbO + Bi₂O₃ is 15-80% by weight,
wherein one of Hf, Ta, W, Re, Os, Ir, Pt, La, Pr, Nd, Sm, Eu,
Gd, Tb, Dy, Ho, Er, Tm, Yb, and Lu are present in oxidic
form in contents of 0-80% by weight,
and a refining agent in customary concentrations,
wherein for a high transmission in the UV region
TiO₂ < 0.1% by weight and
Fe₂O₃ < 0.02% by weight.

25. The backlighting system according to claim 24, wherein said glass envelope includes, for high blocking in the visible wavelength region ≧380 nm, one of CoO being 0.2-10% by weight and NiO being 0.2-15% by weight.

26. The backlighting system according to claim 3, wherein said glass envelope has the following compositions:

| | | |
|---|---|---|
| SiO₂ | 0-85% | by weight, |
| B₂O₃ | >0-35% | by weight |
| Al₂O₃ | 0-20% | by weight |
| Li₂O | <0.5% | by weight |
| Na₂O | <0.5% | by weight |
| K₂O | <0.5% | by weight, wherein |
| Σ Li₂O + Na₂O + K₂O | <1.0% | by weight, |
| MgO | 0-8% | by weight |
| CaO | 0-20% | by weight |
| SrO | 0-20% | by weight |
| BaO | 15-60% | by weight, wherein |
| Σ MgO + CaO + SrO + BaO | 15-70% | by weight, |
| ZrO₂ | 0-3% | by weight |
| WO₃ | 0-3% | by weight |
| Bi₂O₃ | 0-80% | by weight, |
| MoO₃ | 0-3% | by weight, |
| ZnO | 0-10% | by weight, |
| PbO | 0-70% | by weight, wherein |

Σ Al₂O₃ + B₂O₃ + BaO + CsO₂ + PbO + Bi₂O₃ is
15-80% by weight, and a refining agent in customary
concentrations, wherein
TiO₂ < 0.1% by weight and
Fe₂O₃ < 0.02% by weight.

27. The backlighting system according to claim 26, wherein said glass envelope includes one of CoO being 0.2-10% by weight and NiO being 0.2-15% by weight.

28. The backlighting system according to claim 3, wherein said glass envelope has the following compositions:

| | | |
|---|---|---|
| SiO₂ | 35-65% | by weight, |
| B₂O₃ | 0-15% | by weight |
| Al₂O₃ | 0-20% | by weight, |
| Li₂O | 0-0.5% | by weight |
| Na₂O | 0-0.5% | by weight |
| K₂O | 0-0.5% | by weight, wherein |
| Σ Li₂O + Na₂O + K₂O | 0-1% | by weight, and |
| MgO | 0-6% | by weight |
| CaO | 0-15% | by weight |
| SrO | 0-8% | by weight, |
| BaO | 1-20% | by weight |
| ZrO₂ | 0-1% | by weight |
| WO₃ | 0-2% | by weight |
| Bi₂O₃ | 0-20% | by weight |
| MoO₃ | 0-5% | by weight, |
| ZnO | 0-5% | by weight, |
| PbO | 0-70% | by weight, |

Σ Al₂O₃ + B₂O₃ + BaO + PbO + Bi₂O₃ is 8-65% by weight,
wherein one of Hf, Ta, W, Re, Os, Ir, Pt, La, Pr, Nd, Sm, Eu,
Gd, Tb, Dy, Ho, Er, Tm, Yb, and Lu are present in oxidic
form in contents of 0-80% by weight,
and a refining agent in customary concentrations,
wherein
TiO₂ < 0.1% by weight and
Fe₂O₃ < 0.02% by weight.

29. The backlighting system according to claim 28, wherein said glass envelope includes one of CoO being 0.2-10% by weight and NiO being 0.2-15% by weight.

30. The backlighting system according to claim 3, wherein said glass envelope has the following compositions:

| | | |
|---|---|---|
| SiO₂ | 50-65% | by weight |
| B₂O₃ | 0-15% | by weight |
| Al₂O₃ | 1-17% | by weight, |
| Li₂O | 0-0.5% | by weight |
| Na₂O | 0-0.5% | by weight |
| K₂O | 0-0.5% | by weight, wherein |
| Σ Li₂O + Na₂O + K₂O | 0-1% | by weight, |
| MgO | 0-5% | by weight |
| CaO | 0-15% | by weight |
| SrO | 0-5% | by weight |
| BaO | 20-49% | by weight, |
| ZrO₂ | 0-1% | by weight |
| WO₃ | 0-2% | by weight |
| Bi₂O₃ | 0-29% | by weight |
| MoO₃ | 0-5% | by weight, |
| ZnO | 0-3% | by weight, |
| PbO | 0-29% | by weight, |

Σ AI₂O₃ + B₂O₃ + BaO + PbO + Bi₂O₃ is 21-50% by weight,
wherein one of Hf, Ta, W, Re, Os, Ir, Pt, La, Pr, Nd, Sm, Eu,
Gd, Tb, Dy, Ho, Er, Tm, Yb, and Lu are present in oxidic
form in contents of 0-29% by weight,
and a refining agent in customary concentrations,
wherein
TiO₂ < 0.1% by weight and
Fe₂O₃ < 0.02% by weight.

31. The backlighting system according to claim 30, wherein said glass envelope includes one of CoO being 0.2-10% by weight and NiO being 0.2-15% by weight.

32. The backlighting system according to claim 3, wherein one of a) said transparent element has a glass composition including alkali in a content of less than 1.0% by weight, and b) said transparent element includes a layer having a glass composition including alkali in a content of less than 1.0% by weight.

33. The backlighting system according to claim 3, wherein said at least one lighting device is selected from an external electrode fluorescent lamp and a cold-cathode fluorescent lamp.

34. A process of manufacturing a backlighting system for background lighting of at least one of a display and a screen, said process comprising the steps of:
providing at least one lighting device, a transparent element, and a fluorescent layer, said at least one lighting device including a glass envelope and being configured for emitting a radiation, said glass envelope including an outer wall, said transparent element including at least one surface and being configured for being struck by said radiation of said at least one lighting device; and
applying said fluorescent layer at least partly to at least one of said outer wall of said at least one lighting device and said transparent element; and
assembling a reflector together with said at least one lighting device.

35. The process of manufacturing according to claim 34, wherein said step of applying said fluorescent layer occurs by one of spraying a solution containing at least one fluorescent compound, applying a solution containing at least one fluorescent compound, and applying a fluorescent film to said transparent element.
